(19) United States
(12) Patent Application Publication
(10) Pub. No.: US 2013/0229313 A1
(43) Pub. Date: Sep. 5, 2013

(54) ELECTRONIC APPARATUS

(71) Applicant: ASUSTEK COMPUTER INC., Taipei (TW)

(72) Inventor: Min-Yuan CHIU, Taipei (TW)

(73) Assignee: ASUSTEK COMPUTER INC., Taipei (TW)

(21) Appl. No.: 13/718,497

(22) Filed: Dec. 18, 2012

(30) Foreign Application Priority Data
Mar. 1, 2012 (CN) 201210051689.1

(51) Int. Cl. H01Q 1/44

(52) U.S. Cl. CPC H01Q 1/44
USPC 343/702

(57) ABSTRACT

An electronic apparatus includes a casing, a circuit board, and a feeding element. The casing is made of conducting material, and comprises at least one feeding point. The circuit board is disposed in the casing. The feeding element is disposed in the electronic apparatus, and contacts the feeding point of the casing for transmitting signals between the circuit board and the casing, so that the casing functions as a radiation body of an antenna. Accordingly, the signal shielding of the antenna can be avoided, and it is unnecessary to change the material of the casing to plastic, which needs additional manufacturing process. After several times of tests, configuring the feeding point at the corner of the casing can provide higher performance of transmission.

### CROSS REFERENCE TO RELATED APPLICATIONS

This Non-provisional application claims priority under 35 U.S.C. §119(a) on Patent Application No(s). 201210051689.1 filed in People's Republic of China on Mar. 1, 2012, the entire contents of which are hereby incorporated by reference.

### BACKGROUND OF THE INVENTION

1. Field of Invention

The present disclosure relates to an electronic apparatus and, in particular, to an electronic apparatus with an antenna.

2. Related Art

Wireless transmission has been widely applied to electronic products with broadband transmission function for satisfying customers' demands. Thus, the existing electronic products are mostly equipped with the wireless transmission function. In a wireless transmission system, an antenna is needed for transmitting and receiving electromagnetic waves. If the antenna is out of function, the wireless transmission system can not normally transmit or receive data. In other words, the antenna is an indispensable role in the wireless transmission.

In general, the antenna of the electronic apparatus is disposed at the outside of the casing. However, when the casing is made of metal, the radiation body of the antenna is shielded by the metal casing, which results in the increase of the communication dead space and thus the decrease of the communication performance. To solve this problem, the material of the entire casing or a part of the casing configured with the antenna is replaced by plastic material. Unfortunately, this method needs to change the manufacturing process, which increases the manufacturing cost and time. Otherwise, the manufacturer can follow the conventional manufacturing process without any modification, and destructively accept the configuration with some losses in the antenna performance.

### SUMMARY OF THE INVENTION

The present disclosure provides an electronic apparatus comprising a casing, a circuit board and a feeding element. In one aspect, the casing is made of conducting material, and the circuit board is disposed in the casing. The casing comprises at least one feeding point. The feeding element is disposed in the electronic apparatus, and contacts the feeding point of the casing for transmitting signals between the circuit board and the casing, so that the casing functions as a radiation body of an antenna. In one aspect, the feeding point is disposed at the corner of the casing.

As mentioned above, the electronic apparatus of the disclosure is configured with the feeding element for transmitting signals between the circuit board and the casing made of conductive material rather than an additional antenna. Thus, the casing is functioned as an antenna radiation body so as to achieve the desired antenna function. Accordingly, the signal shielding of the antenna can be avoided, and it is unnecessary to change the material of the casing to plastic, which needs additional manufacturing process. After several times of tests, configuring the feeding point at the corner of the casing can provide higher performance of transmission.

These and other features, aspects and advantages of the present invention will become better understood with regard to the following description, appended claims, and accompanying drawings.

### BRIEF DESCRIPTION OF THE DRAWINGS

FIG. 1 is a schematic diagram of an electronic apparatus according to a first embodiment of the disclosure;

FIG. 2 is a side view of a part of an electronic apparatus according to a second embodiment of the disclosure; and

FIG. 3 is a top view of a circuit board of an electronic apparatus according to a preferred embodiment of the disclosure.

### DETAILED DESCRIPTION OF THE INVENTION

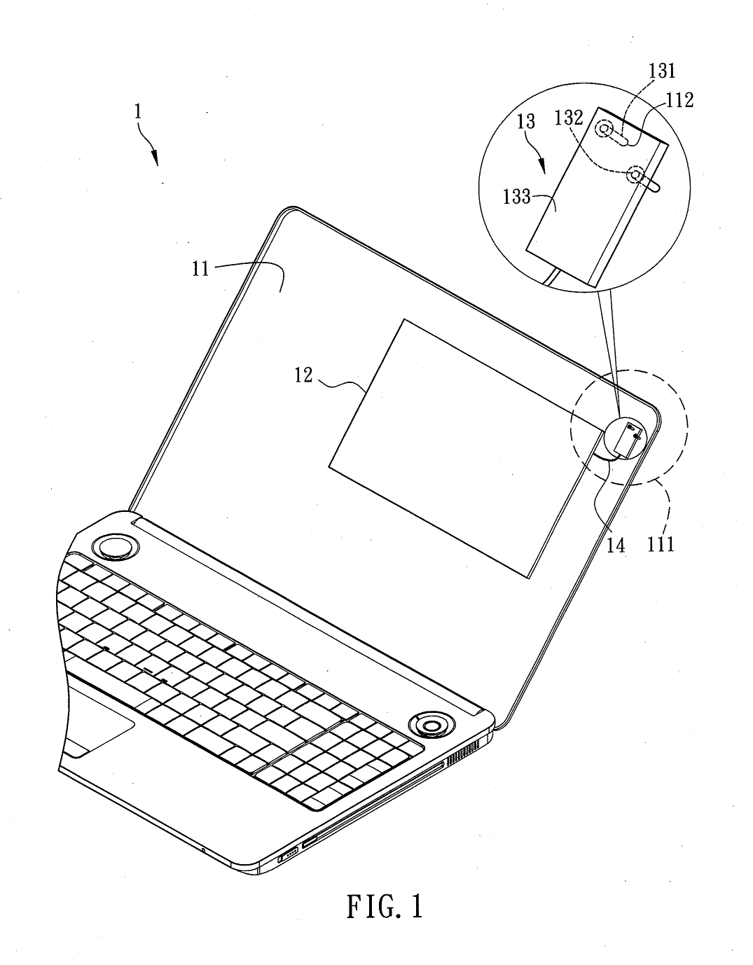

FIG. 1 is a schematic diagram of an electronic apparatus 1 according to a first embodiment of the disclosure. The electronic apparatus 1 of this embodiment is a laptop computer for example. Of course, the electronic apparatus 1 may also be a computer (e.g. a tablet PC), a portable communication device (e.g. a mobile phone), a network communication device (e.g. a wireless AP), or the likes.

To clarify the technical features of this embodiment, FIG. 1 only shows the casing instead of the entire screen of the laptop computer. The electronic apparatus 1 includes a casing 11, a circuit board 12 and a feeding element 13. In this case, the casing 11 is the casing of the laptop computer, and it is made of conductive material, which comprises a metal (e.g. aluminum), several metals, or an alloy. Besides, the casing 11 has at least one feeding point 112.

The circuit board 12 is disposed inside the casing 11. For example, the circuit board 12 is disposed on the main board of the laptop computer. In general, the circuit board 12 can drive the laptop computer to execute an operation or enabling the display panel and/or backlight module. In this embodiment, the circuit board 12 can further provide signal to the feeding element 13.

The feeding element 13 is disposed inside the electronic apparatus 1 and, in particular, inside the casing 11. Besides, the feeding element 13 contacts the feeding point 112 for transmitting signals between the circuit board 12 and the casing 11, so that the casing 11 can function as the radiation body of the antenna. In this embodiment, the feeding element 13 is connected to the feeding point 112 disposed at a corner 111 of the casing 11. Of course, the position of the feeding point 112 can be adjusted based on the needed characteristic of the antenna.

In this embodiment, the feeding element 13 includes a feeding terminal 131 and a grounding terminal 132, which are connected with the casing 11. The feeding terminal 131 is connected with the feeding point 112 of the casing 11 for transmitting signals between the circuit board 12 and the casing 11. The feeding terminal 131 and the grounding terminal 132 can be connected to the casing 11 by, for example, soldering, adhering, locking or wedging. In this case, the feeding terminal 131 and the grounding terminal 132 can be connected to the casing 11 by wedging. Besides, the feeding terminal 131 and the grounding terminal 132 are made of conductive material such as a metal, several metals, or an alloy. In addition, the feeding element 13 further comprises a substrate 133, and the feeding terminal 131 and the grounding terminal 132 are fixed on the substrate 133 by, for example, soldering.

Furthermore, the feeding element 13 is electrically connected to the circuit board 12 through a conductive element 14, such as a coaxial cable. In general, the coaxial cable includes a conductive body, a grounding conductor, and an insulation layer. The conductive body is electrically connected with the feeding terminal 131, the grounding conductor is electrically connected with the grounding terminal 132m, and the insulation layer is disposed between the conductive body and the grounding conductor for isolating the electrical signals therebetween.

In one embodiment, the feeding signal is provided by the circuit board 12 and then transmitted to the casing 11 through the conductive element 14 and the feeding element 13, thereby forming a specific current path so as to achieve the desired antenna transmission function. The above-mentioned current path can be achieved by the structural design of the casing 11. The current path varies based on the application frequencies and bandwidths, and it is not limited in this embodiment. For example, the application frequency of IEEE 802.11b/g is between about 2.4-2.5 GHz, and accordingly, the length of the current path is designed to be equal to ¼ of the wavelength of the applied frequency. Of course, the electronic apparatus 1 of the embodiment can be applied to any bandwidth such as the working bands of WLAN a/b/g/n, WiMAX, and UWB.

Moreover, this disclosure is not limited to dispose the feeding point at a single corner, and it is possible to dispose multiple feeding points at several corners depending on the actual needs. The multiple feeding points can be used for different feeding signals so as to achieve the effects of broadband and wider bandwidth.

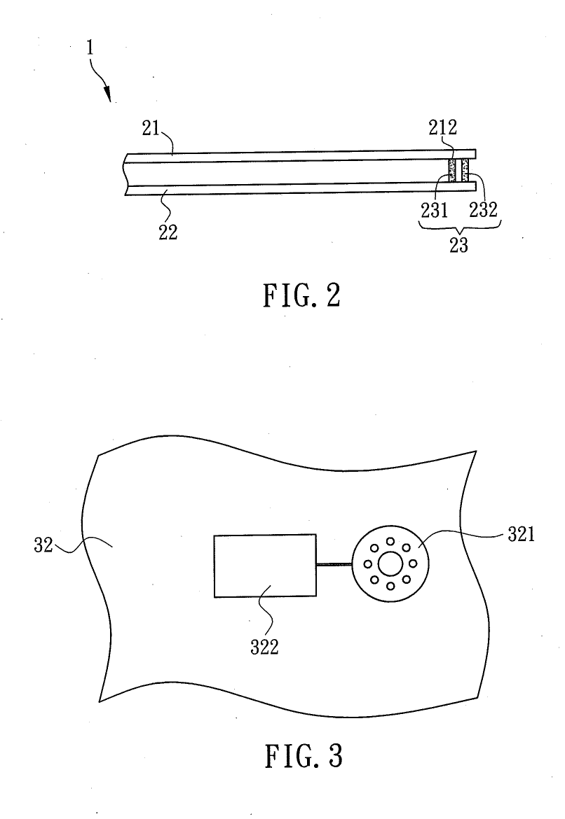

FIG. 2 is a side view of a part of an electronic apparatus 2 according to a second embodiment of the disclosure. The electronic apparatus 2 includes a casing 21, a circuit board 22 and a feeding element 23. The feeding element 23 has a feeding terminal 231 and a grounding terminal 232. Different from the first embodiment, the feeding terminal 231 and the grounding terminal 232 of the feeding element 23 are directly fixed between the circuit board 22 and the casing 21. The feeding element 23 is configured to transmitting signals between the circuit board 22 and the casing 21, so that the casing 21 can function as a radiation body of the antenna.

FIG. 3 is a top view of a circuit board 32 of an electronic apparatus according to a preferred embodiment of the disclosure. The circuit board 32 can be applied to any of the above-mentioned embodiments (e.g. the circuit board 12 or 22). The circuit board 32 has at least one screw hole 321 for fixing the circuit board 32, and a notch circuit 322 is disposed around the screw hole 321. In general, the notch circuit 322 is a filter circuit, which includes a series LC resonant circuit. The notch circuit 322 is characterized in having zero resistance (0) to the resonant frequency signal and unlimited resistance (00) to other frequency signals. The current flows from the feeding point to the grounding point of the system. In order to inhibit the current to flow through the grounding terminal of the circuit board 32 so as to simplify the current path, the present embodiment is to configure the notch circuit 322 around the screw hole 321, so that the current (e.g. 2.4 GHz current) can not be transmitted to the circuit board 32 through the screw hole 321.

In summary, the electronic apparatus of the disclosure does not include the additional antenna but is configured with the feeding element electrically connected with the feeding point of the casing made of conductive material, thereby transmitting signals between the circuit board and the casing by the feeding element. Thus, the casing is functioned as an antenna radiation body so as to achieve the desired antenna function. Accordingly, the signal shielding of the antenna can be avoided, and it is unnecessary to change the material of the casing to plastic, which needs additional manufacturing process. In other embodiments, when the feeding point is configured at the corner of the casing, it can provide higher performance of transmission.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electronic apparatus, comprising:
a casing made of conducting material and comprising at least one feeding point;
a circuit board disposed in the casing; and
a feeding element disposed in the electronic apparatus and contacting the feeding point of the casing for transmitting signals between the circuit board and the casing, so that the casing functions as a radiation body of an antenna.

2. The electronic apparatus of claim 1, wherein the at least one feeding point is disposed at a corner of the casing.

3. The electronic apparatus of claim 1, wherein the feeding element is electrically connected with the circuit board through a conductive element.

4. The electronic apparatus of claim 1, wherein the feeding element is fixed on the circuit board.

5. The electronic apparatus of claim 1, wherein the circuit board has at least one screw hole for fixing the circuit board.

6. The electronic apparatus of claim 5, wherein a notch circuit is configured around the screw hole.
